(19) United States
(12) Patent Application Publication
(10) Pub. No.: US 2014/0251164 A1
(43) Pub. Date: Sep. 11, 2014

(54) Food Preparation Appliance

(71) Applicants: Ehsan Alipour, San Francisco, CA (US); Joseph Benjamin Strecker, Half Moon Bay, CA (US); Farshad Moinzadeh, Greenbrae, CA (US)

(72) Inventors: Ehsan Alipour, San Francisco, CA (US); Joseph Benjamin Strecker, Half Moon Bay, CA (US); Farshad Moinzadeh, Greenbrae, CA (US)

(21) Appl. No.: 14/199,230

(22) Filed: Mar. 6, 2014

Related U.S. Application Data
(60) Provisional application No. 61/773,678, filed on Mar. 6, 2013.

(51) Int. Cl. A47J 39/00

(52) U.S. Cl. CPC A47J 39/006
USPC 99/483

(57) ABSTRACT

A food preparation apparatus includes a thermal fluid reservoir formed with an internal cavity for holding a thermal transfer fluid. A fluid transfer unit circulates the thermal transfer fluid through the reservoir and through a thermal transfer unit. The thermal fluid reservoir may be formed into a food receptacle with a thermal contact surface for the reservoir coincident with a food contact surface in the receptacle. Alternatively, a food receptacle may be formed separately from the reservoir and may either attach to the thermal contact surface or may be easily removable. Embodiments may selectively heat or cool food in the food receptacle by transferring thermal energy between the thermal transfer fluid and the thermal contact surface. A setpoint temperature is accurately maintained everywhere on the thermal transfer surface to avoid hot spots or cold spots in the food receptacle.

### CROSS REFERENCE TO RELATED APPLICATIONS

This application claims priority to U.S. Provisional Patent Application No. 61/773,678, titled “Cooking Chamber Device”, filed Mar. 6, 2013, and incorporated herein by reference in its entirety.

### FIELD OF THE INVENTION

Embodiments of the invention are related generally to an article of food preparation equipment for changing a temperature of a food item and more specifically to a food preparation appliance having a thermal fluid reservoir for achieving accurate temperature control of a thermal transfer surface adapted for contact with a food item.

### BACKGROUND

Preparation of a food item may require a change in the temperature of the food item, either by heating or cooling the food item. It may be preferable to accurately achieve a selected temperature for the food item for a selected time duration. However, point-to-point variations in thermal energy transfer between a food item and a surface contacting the food item may cause unwanted variations in the visual appearance, nutritional value, or flavor of the food item. For example, cooking stoves or hot plates using flames, electrically powered resistive heating coils, or electrically powered inductive coils to heat a cooking pot, griddle, or other cooking vessel may subject some parts of the vessel to intense heat while other parts are exposed to much lower temperatures. Hot spots or cold spots may develop in different parts of the cooking vessel and in different parts of the food item. Temperature variations on the interior bottom and sides of a cooking vessel may exceed tens or even hundreds of degrees, possibly leading to unpredictable or unwanted cooking results.

Experienced cooks learn to adjust the position of a cooking vessel relative to a heat source, the positions of food items in a cooking vessel, cooking times, and the temperature settings of the cooking appliance to avoid overcooking or undercooking food and to avoid damaging the cooking vessel. However, changes in the size, weight, or number of food items being cooked or replacing one cooking vessel with another may require much experimentation with different combinations of cooking temperatures and cook times to compensate for changes in the amount of thermal energy transferred into the food.

### SUMMARY

An example of a food preparation appliance in accord with an embodiment of the invention includes a thermal fluid reservoir formed with an internal cavity for holding a thermal transfer fluid. The thermal fluid reservoir includes a thermal contact surface adapted for transferring thermal energy between the thermal fluid reservoir and a food item. The appliance further includes a fluid transfer unit in fluid communication with the internal cavity in the thermal fluid reservoir and a thermal transfer unit in fluid communication with the fluid transfer unit and with the internal cavity in the thermal fluid reservoir. The example of a food preparation appliance also includes a temperature and flow controller in electrical communication with the fluid transfer unit and the thermal transfer unit and a user interface module in electrical communication with the temperature and flow controller. The temperature and flow controller is adapted to maintain a temperature of the thermal contact surface at a setpoint temperature received by the temperature and flow controller from the user interface module.

Another example of an apparatus in accord with an embodiment of the invention includes a thermal fluid reservoir formed with an internal cavity for holding a thermal transfer fluid, the thermal fluid reservoir including a thermal contact surface. The apparatus further includes a food receptacle adapted for a close fit against the thermal fluid reservoir and a fluid transfer unit in fluid communication with the internal cavity in the thermal fluid reservoir. The example of an apparatus also includes a thermal transfer unit in fluid communication with the fluid transfer unit and with the internal cavity in the thermal fluid reservoir, a temperature and flow controller in electrical communication with the fluid transfer unit and the thermal transfer unit, and a user interface module in electrical communication with the temperature and flow controller. The temperature and flow controller is adapted to maintain a temperature of the thermal contact surface at a setpoint temperature received by the temperature and flow controller from the user interface module. The food receptacle may be attached to the thermal contact surface or may alternatively be adapted for easy removal and reinstallation in the apparatus.

### BRIEF DESCRIPTION OF THE DRAWINGS

FIG. 1 is a simplified schematic representation of a food preparation appliance in accord with an embodiment of the invention.

FIG. 2 is a side view of an example of a food receptacle for use with an embodiment of the invention.

FIG. 3 is a schematic representation of an alternative embodiment of a food preparation appliance adapted for use with a removable food receptacle.

FIG. 4 is a side view of an example of a food receptacle having a channel formed on a bottom side of the receptacle and having more than one void for holding food items.

FIG. 5 is a view toward a food contact surface of the example of a food receptacle from FIG. 4.

FIG. 6 is a schematic representation of a closed loop fluid path including a thermal fluid reservoir having a ridge adapted to engage a corresponding channel in a food receptacle.

### DESCRIPTION

Embodiments of the invention comprise an appliance for preparation of a food item by subjecting the food item to contact with a thermal transfer surface having a uniform, accurately controlled surface temperature. The surface temperature of the thermal transfer surface is approximately equal to a temperature of a thermal transfer fluid in a thermal fluid reservoir in good thermal contact with the thermal transfer surface. In some embodiments of the invention, a surface of the thermal fluid reservoir is formed into a food receptacle for holding a food item during heating or cooling of the food item. In alternative embodiments of the invention, a separate food receptacle is placed in good thermal contact with the thermal transfer surface of the thermal fluid reservoir. A food receptacle may alternatively be attached to the thermal transfer surface or may be easily separable from the thermal fluid reservoir.

Embodiments of the invention are advantageous for subjecting a food item to a uniform, accurately controlled food preparation temperature which remains within a narrow range of a setpoint temperature selected by a user. For example, a temperature of a surface provided for exchanging thermal energy with a food item may be held within a range of plus or minus one degree Celsius of a user-selected setpoint temperature, a range that is substantially smaller than for a conventional gas or electric stove. Other advantages of the embodiments of the invention include, but are not limited to, accurate control of a food preparation temperature when a number of food items being cooked simultaneously in one food receptacle changes, when a size or weight of each food item is substantially different than for previously prepared, similar food items, and accurate control of a uniform temperature for food receptacles of different sizes and shapes. Some embodiments of the invention are adapted for heating one or more food items simultaneously. Other embodiments of the invention are adapted for cooling, and possible freezing, at least one food item. Some embodiments of the invention may selectively heat or cool a food item as directed by a person using the food preparation appliance. Some embodiments of the invention are particularly advantageous for heating food items which are easily damaged by scorching, for example milk, butter, cheese, chocolate, and foods with high dairy or sugar content.

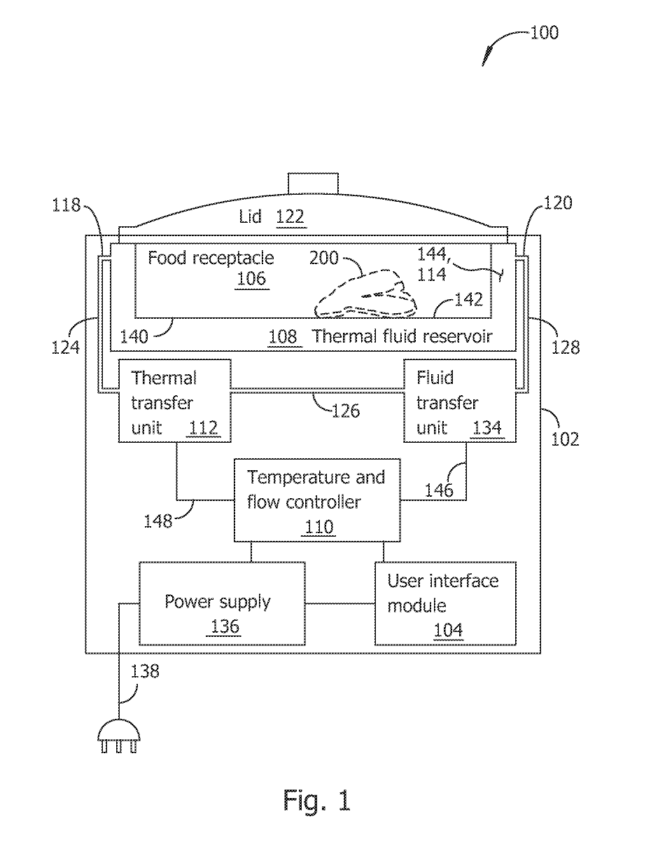

An example of a food preparation appliance in accord with an embodiment of the invention is shown in simplified schematic form in FIG. 1. In the example of FIG. 1, a food preparation appliance 100 includes a thermal fluid reservoir 108 formed into the shape of a food receptacle 106. The food receptacle 106 has a size and shape selected for holding a selected number of an example of a food item 200 to be prepared by exposing the food item to a uniform temperature achieved by circulation of a thermal transfer fluid 114 through a cavity 144 inside the thermal fluid reservoir 108. The example of a food item 200 is not included in an embodiment of the invention. Examples of a food receptacle 106 suitable for use with an embodiment of the invention include, but are not limited to, a sous vide immersion cooker, a frying pan, a sauté pan, a pot, a griddle with an approximately flat upper cooking surface and low sides around the cooking surface, a dutch oven, a pan shaped for baking a loaf of bread, a tray formed with multiple voids for holding multiple food items such as cupcakes, an ice cream maker, an ice cube tray, a chilled serving tray, a heated serving tray, a chilled buffet serving dish, a heated buffet serving dish, a coffee maker, and so on.

In FIG. 1, the food item 200 rests on a food contact surface 142 of the food receptacle 106. In the example of FIG. 1, the food contact surface 142 corresponds to a thermal contact surface 140 of the thermal fluid reservoir 108. Although the food contact surface 142 is shown by a straight line in FIG. 1, representing an approximately planar food contact surface, in alternative embodiments the food contact surface may be convex, concave, irregularly curved, or formed with ridges, bumps, or indentations.

The thermal fluid reservoir 108 forms part of a closed-circuit fluid path including a thermal transfer unit 112 and a fluid transfer unit 134. Thermal transfer fluid 114 flows without escaping from the closed-circuit fluid path. Thermal transfer fluid 114 flows from the thermal fluid reservoir 108 through a thermal fluid outlet 120 and a first fluid conduction line 128 to a fluid transfer unit 134. The fluid transfer unit 134 is in fluid communication with the thermal transfer unit 112 through a second fluid conduction line 126. Thermal transfer fluid 114 exiting the thermal transfer unit 112 enters a third fluid conduction line 124 and returns to the thermal fluid reservoir 108 by a thermal fluid inlet 118 on the reservoir 108. The food contact surface 142 of the food receptacle 106 achieves a temperature approximately equal to the temperature of the thermal transfer fluid 114 everywhere the food contact surface is adjacent the thermal fluid reservoir, for example the interior bottom and interior sides of the food receptacle 106 in the example of FIG. 1.

The thermal transfer fluid 114 may be in a liquid state throughout the closed-loop fluid flow path. Alternatively, the thermal transfer fluid may be in a gaseous state in some parts of the fluid flow path and in a liquid state in other parts of the fluid flow path. Examples of a thermal transfer fluid include, but are but limited to, water, silicone oil, cooking oil, mixtures of water and alcohol, and air conditioning refrigerant. When water is used as a thermal transfer fluid, the freezing point of the thermal transfer fluid may be lowered and the boiling point elevated by adding a soluble compound to the water, for example a salt such as sodium chloride or potassium chloride.

The thermal transfer unit 112 may alternatively be implemented as a heating unit, a cooling unit, or as a combined heating and cooling unit. Some embodiments of the invention include more than one thermal transfer unit arranged in a series fluid circuit or alternatively in a parallel fluid circuit or a combination series-parallel fluid circuit. Examples of a thermal transfer unit 112 include, but are not limited to, a resistive electric heater, an inductive electric heater, an infrared heater, a microwave transmitter, a refrigeration heat exchanger, and a solid-state thermoelectric device adapted for heating and cooling.

The fluid transfer unit 134 may alternatively be selected to circulate a fluid for heating, for cooling, or for heating and cooling through the closed-loop fluid path. Examples of a fluid transfer unit 134 include, but are not limited to, a piston pump, a centrifugal pump, a screw pump, a positive displacement pump, and a compressor, for example an air conditioning compressor.

The temperature of the thermal transfer fluid 114 in the thermal fluid reservoir, and therefore the temperature everywhere on the food contact surface 142, is controlled by a temperature and flow controller 110 operating in response to settings entered by a person into a user interface module 104 electrically connected to the controller 110. The controller 110 outputs a temperature control signal 148 on an electrical line to the thermal transfer unit 112 to direct the thermal transfer unit 112 to modify the temperature of the thermal transfer fluid 114. The controller 110 may further output a flow rate control signal 146 on an electrical line to the fluid transfer unit 134. The controller 110 may alternatively adjust the operation of the thermal transfer unit 112, the fluid transfer unit 134, or both units to accurately achieve a temperature for the thermal contact surface 140 approximately equal to a setpoint temperature from the user interface module 104. The controller 110 optionally includes signal conditioning circuitry for driving the thermal transfer unit 112 and the fluid transfer unit 134. Examples of a controller 110 include a microprocessor implemented in hardware, a microcontroller implemented in hardware, an application-specific integrated circuit implemented in hardware, a gate array implemented in hardware, and a programmable gate array implemented as a hardware circuit device.

A power supply module 136 receives electrical power from an external source through a power cord 138. The power supply module may optionally include a circuit interrupting device, for example any one or more of a circuit breaker, a switch, a fuse, and a ground-fault circuit interrupter. The power supply module 136 outputs electrical power to the controller 110 and user interface module 104 and outputs electrical power consumed by the thermal transfer unit 112 and fluid transfer unit 134.

The user interface module 104 includes switches and display indicators for use by a person operating an embodiment of the invention 100. Switches may be provided for operations including, but not limited to, turning appliance power on and off, setting a start time and optionally a time duration for operating the food receptacle 106 at a selected temperature, and selecting a setpoint temperature of the food contact surface 142, corresponding to a surface temperature of a food item in the appliance. Examples of a display indicator include, but are not limited to, one or more discrete light emitting diodes (LED), incandescent lamps, or neon bulbs, a flat panel display adapted to display alphanumeric and optionally graphic information, a liquid crystal display, a vacuum florescent display, and an LED display.

The thermal fluid reservoir 108, food receptacle 106, controller 110, and other components in the example of FIG. 1 may be enclosed in a housing 102 to protect appliance components from damage and protect a user of the appliance from contact with dangerous temperatures and hazardous voltages and currents. The user interface module 104 may be attached to an exterior surface of the housing 102 or may alternately be enclosed within the housing with switches and display indicators accessible through apertures in the housing. A lid 122 may optionally be provided to close the food receptacle 106 and improve temperature control in the cooking vessel. The lid 122 may optionally be fabricated from an efficient thermal insulator.

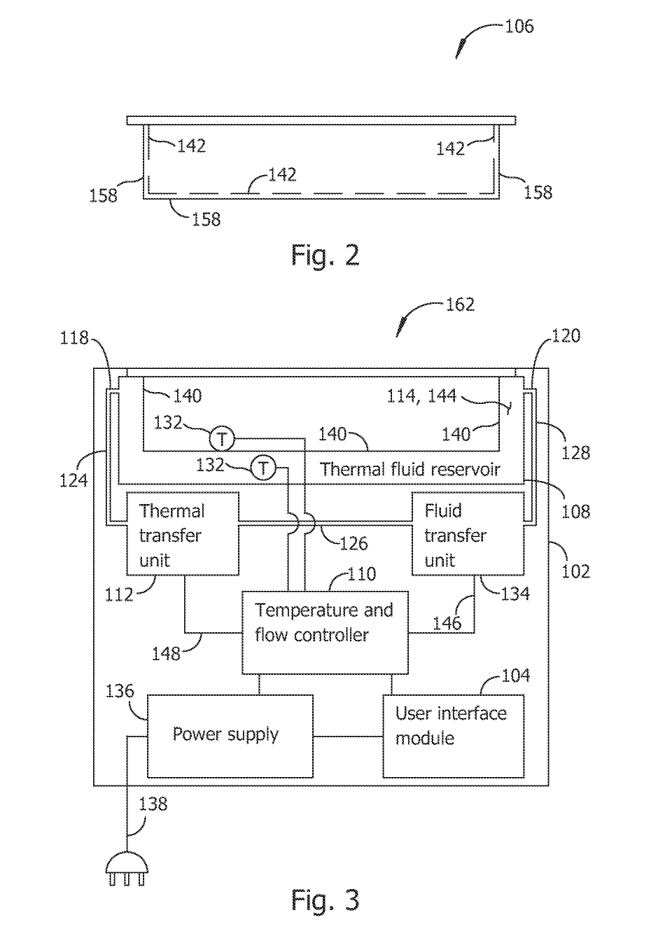

In the example of FIG. 1, the thermal contact surface of the thermal fluid reservoir and the food contact surface of the food receptacle are coincident, that is, they are the same surface. In an alternative embodiment of a food preparation appliance 100, the food contact surface and the thermal contact surface of the reservoir are different surfaces that come into good thermal contact with one another when the appliance is operating. FIGS. 2 and 3 show an example of a food receptacle 106 and a base assembly 162 for a food preparation appliance in which the food contact surfaces 142 on the interior of a food receptacle 106 and the thermal contact surface 158 of the food receptacle are formed separately from the thermal contact surfaces 140 for the thermal fluid reservoir 108. The size and shape of the food receptacle 106 is preferably chosen so that the thermal contact surfaces 158 on the receptacle fit closely against the thermal contact surfaces 140 of the thermal fluid reservoir 108 in the base assembly 162.

In the example of FIGS. 2 and 3, the food receptacle 106 is formed separately from the thermal fluid reservoir 108. The food receptacle may be attached to the thermal contact surface 140 of the thermal fluid reservoir 108. Or, as suggested in FIGS. 2 and 3, the food receptacle 106 may be adapted for easy removal and re-insertion into the thermal fluid reservoir 108. The exterior surfaces of a removable food receptacle preferably fit closely against the thermal fluid reservoir when the food receptacle is installed in the base assembly 162. A close fit between the food receptacle and the thermal food reservoir minimizes an air gap between the thermal contact surfaces 150 of the food receptacle and the thermal contact surface 140 of the thermal fluid reservoir 108, thereby improving the efficiency of thermal energy transfer between the receptacle and reservoir and reducing deviations between the measured temperature of the thermal contact surface 140 of the reservoir and a setpoint temperature received from the user interface module 104.

FIG. 3 further illustrates the use of at least one temperature sensor 132 electrically connected to the controller 110. At least one temperature sensor 132 may be positioned in good thermal contact with one or more selected locations on the thermal contact surface 140. Another temperature sensor 132 may optionally be positioned to measure a temperature of the thermal transfer fluid 114 inside the cavity 144 in the thermal fluid reservoir 108. Closed-loop feedback control of thermal contact surface temperature is implemented by the cooperative interaction of the controller 110, temperature sensor 132, thermal transfer unit 112, and fluid transfer unit 134. Briefly, the controller 110 drives the thermal transfer unit, and optionally the fluid transfer unit, to minimize a difference between a measured value of temperature from a temperature sensor and a setpoint value of temperature received from the user interface module and stored in the controller. Temperature deviations measured by the controller 110 from a setpoint temperature may be less than one degree Celsius over the full operating temperature range achievable by the thermal transfer unit 112 and fluid transfer unit 134. Temperature variations from one location to another on the thermal contact surface 140 may be less than one degree Celsius when the controller 110 is managing the thermal transfer unit 112 and fluid transfer unit 134.

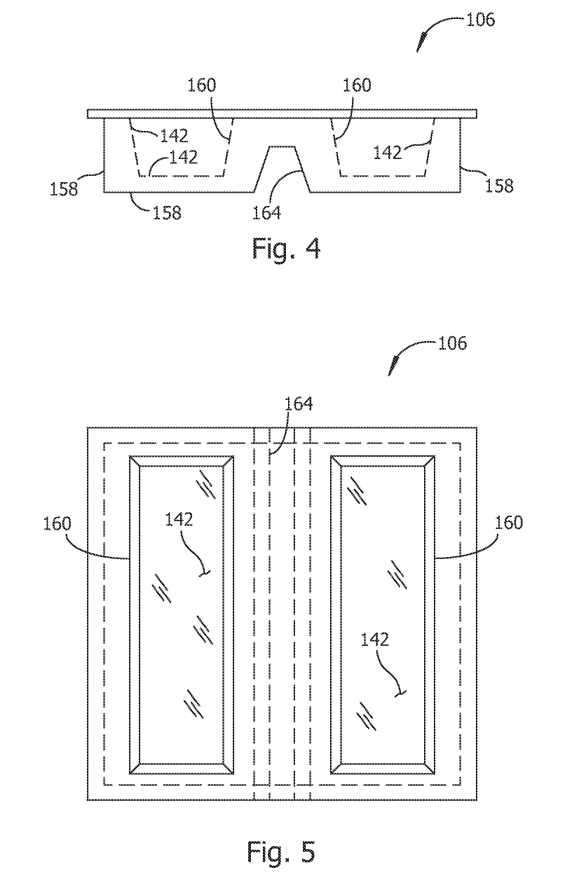

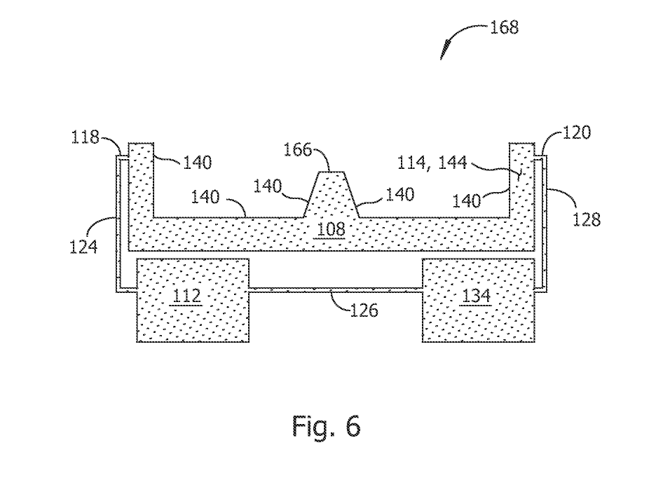

The food receptacle 106 in the example of FIG. 2 is formed with a single void for holding a food item. The example of a food receptacle 106 shown in a side view in FIG. 4 and a top view in FIG. 5. includes more than one void 160 for holding food items. The food receptacle in FIGS. 5 and 6 further illustrates an example of a food receptacle 106 having a channel 164 adapted to fit over a corresponding ridge in a thermal fluid reservoir in a base assembly. The channel 164 has a size and shape selected to provide even, rapid thermal energy transfer between food items in the voids 160 and thermal transfer fluid flowing through the thermal fluid reservoir. More than one channel 164 may optionally be provided.

FIG. 6 provides a schematic representation of a fluid reservoir 108 having a ridge 166 formed in the reservoir and thermal contact surface 140. The ridge 166 preferably fits closely into the corresponding channel 164 in a food receptacle, for example the receptacle 106 in the example of FIGS. 4-5, and has a size, shape, and location selected to provide accurate control of a uniform surface temperature everywhere on thermal contact surface 140. As suggested in FIG. 6, thermal contact surface 140 may optionally include any one or more of ridges, channels, and walls through which thermal transfer fluid 114 may flow in a closed-loop fluid path 168. The closed-loop fluid path 168 includes all the components in fluid communication with one another. Components in fluid communication with one another are marked by stippling in FIG. 6. Although the examples of FIGS. 4-6 show a ridge adapted to fit closely into a channel, in alternative embodiments of the invention, protrusions of almost any shape may replace the ridge and depressions shaped to receive the protrusions may replace the channel. Furthermore, an embodiment of the invention may include a food receptacle 106 having more than two voids 160 for holding food items.

Unless expressly stated otherwise herein, ordinary terms have their corresponding ordinary meanings within the respective contexts of their presentations, and ordinary terms of art have their corresponding regular meanings.

1. An apparatus, comprising:
a thermal fluid reservoir formed with an internal cavity for holding a thermal transfer fluid, comprising a thermal contact surface adapted for transferring thermal energy between said thermal fluid reservoir and a food item;
a fluid transfer unit in fluid communication with said internal cavity in said thermal fluid reservoir;
a thermal transfer unit in fluid communication with said fluid transfer unit and with said internal cavity in said thermal fluid reservoir;
a temperature and flow controller in electrical communication with said fluid transfer unit and said thermal transfer unit; and
a user interface module in electrical communication with said temperature and flow controller,
wherein said temperature and flow controller is adapted to maintain a temperature of said thermal contact surface at a setpoint temperature received by said temperature and flow controller from said user interface module.

2. The apparatus of claim 1, wherein said thermal transfer unit comprises a resistive electric heater.

3. The apparatus of claim 1, where said thermal transfer unit comprises an infrared heater.

4. The apparatus of claim 1, wherein said thermal transfer unit comprises a microwave transmitter.

5. The apparatus of claim 1, wherein said thermal transfer unit comprises a solid-state thermoelectric device adapted for heating and cooling.

6. The apparatus of claim 1, wherein said fluid transfer unit comprises a positive displacement pump.

7. The apparatus of claim 1, wherein said thermal fluid reservoir is formed into a food receptacle with said thermal contact surface corresponding to an inner bottom surface of said food receptacle.

8. The apparatus of claim 1, further comprising a temperature sensor adapted to measure a temperature of a thermal transfer fluid inside said thermal fluid reservoir.

9. The apparatus of claim 1, further comprising a temperature sensor adapted to measure a temperature of said thermal contact surface.

10. The apparatus of claim 9, wherein said temperature and flow controller, said temperature sensor, said thermal transfer unit, and said fluid transfer unit implement closed-loop feedback control of said temperature of said thermal contact surface.

11. An apparatus, comprising:
a thermal fluid reservoir formed with an internal cavity for holding a thermal transfer fluid, comprising a thermal contact surface;
a food receptacle adapted for a close fit against said thermal fluid reservoir;
a fluid transfer unit in fluid communication with said internal cavity in said thermal fluid reservoir;
a thermal transfer unit in fluid communication with said fluid transfer unit and with said internal cavity in said thermal fluid reservoir;
a temperature and flow controller in electrical communication with said fluid transfer unit and said thermal transfer unit; and
a user interface module in electrical communication with said temperature and flow controller,
wherein said temperature and flow controller is adapted to maintain a temperature of said thermal contact surface at a setpoint temperature received by said temperature and flow controller from said user interface module.

12. The apparatus of claim 11, wherein said food receptacle is adapted for easy removal and reinstallation in said apparatus.

13. The apparatus of claim 11, wherein said thermal transfer unit comprises a resistive electric heater.

14. The apparatus of claim 11, where said thermal transfer unit comprises an infrared heater.

15. The apparatus of claim 11, wherein said thermal transfer unit comprises a heat exchanger.

16. The apparatus of claim 11, wherein said thermal transfer unit comprises a solid-state thermoelectric device adapted for heating and cooling.

17. The apparatus of claim 11, wherein said fluid transfer unit comprises a positive displacement pump.

18. The apparatus of claim 11, wherein said thermal fluid reservoir is formed with a protrusion through which thermal transfer fluid may flow and said food receptacle is formed with a depression adapted to receive said protrusion.

19. The apparatus of claim 11, further comprising a temperature sensor adapted to measure a temperature of said thermal contact surface.

20. The apparatus of claim 19, wherein said temperature and flow controller, said temperature sensor, said thermal transfer unit, and said fluid transfer unit implement closed-loop feedback control of said temperature of said thermal contact surface.
